(19) United States
(12) Patent Application Publication
(10) Pub. No.: US 2021/0155525 A1
(43) Pub. Date: May 27, 2021

(54) METHOD FOR BREAKING OUT A SHEET OF GLASS

(71) Applicant: SAINT-GOBAIN GLASS FRANCE, COURBEVOIE (FR)

(72) Inventors: Axel NOGRET, PARIS (FR); Thierry DUMENIL, MARGNY LES COMPIEGNE (FR); Dominique BURELOUX, OGNES (FR)

(21) Appl. No.: 16/612,578

(22) PCT Filed: May 7, 2018
(86) PCT No.: PCT/FR2018/051144

§ 371 Date: Nov. 11, 2019

(30) Foreign Application Priority Data
May 19, 2017 (FR) 1754451

(51) Int. Cl. C03B 33/033; C03B 33/04

(52) U.S. Cl. CPC C03B 33/033; C03B 33/04

(57) ABSTRACT

A method for breaking out a sheet of glass includes tracing a score line on a first face of the sheet of glass, the score line delimiting an exterior part and an interior part of the sheet of glass, positioning a support facing the score line on the side of the sheet of glass opposite to the first face, and breaking out by simultaneous application of at least a first force on the exterior part of the sheet of glass and of at least a second force on the interior part of the sheet of glass.

The present invention relates to the field of breaking out a sheet of glass, more particularly a breaking-out method.

The method according to the present invention is particularly—although nonlimitingly—designed for breaking out a sheet of glass of small thickness, notably of a thickness less than or equal to 1 mm, in particular less than or equal to 0.7 mm.

It will be recalled that breaking out a sheet of glass is performed in at least two successive operations:

a preliminary operation of tracing one or more score lines or surface fissures onto the surface of the glass; these fissures form lines corresponding to the contours of the glazing that is to be cut out; this operation is referred to as the “scoring” operation;

an operation of spreading the initial surface fissure through the thickness of the sheet of glass; this operation is referred to as the “breaking out” operation.

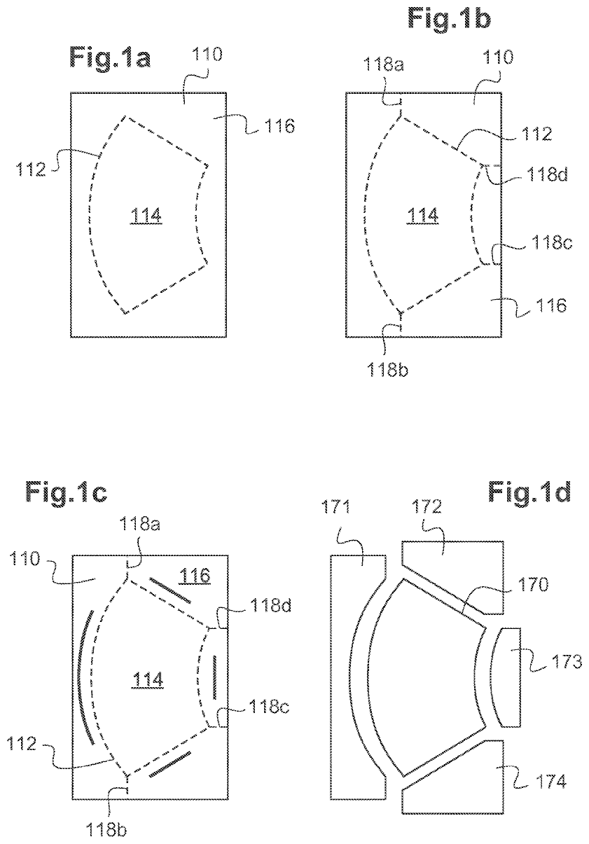

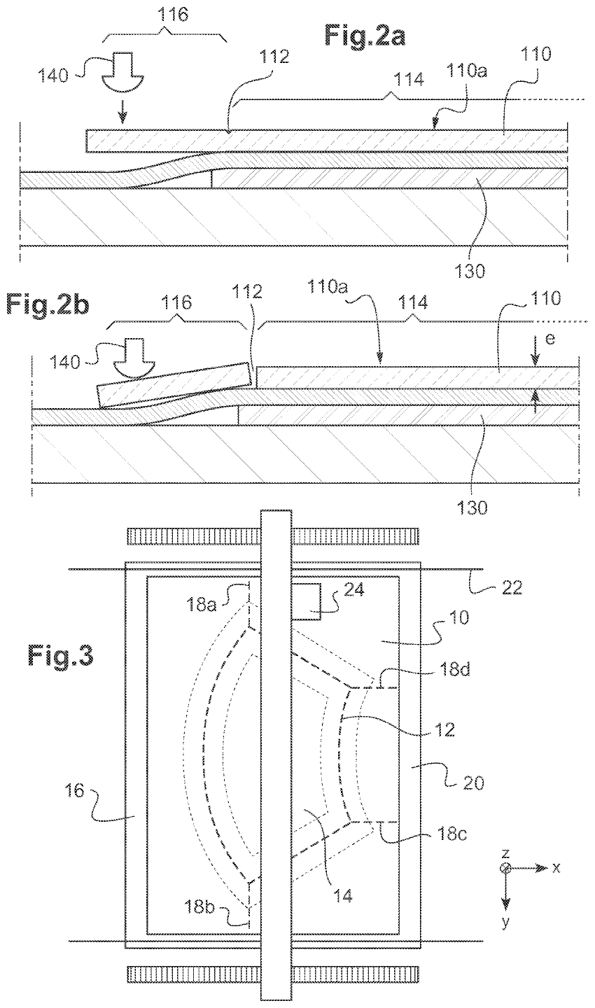

One known method for breaking out glass, which is applied to the manufacture of automotive glazing, typically windshields, is described hereinafter with reference to FIGS. 1a to 1d and 2a, 2b.

A sheet of glass 110 referred to as the primitive, having the shape of a square, a rectangle or a trapezium, is provided.

A score line 112 corresponding to the contour of the shape (i.e. of the glazing) that is to be cut out is traced (FIG. 1a) on a first face 110a of the sheet of glass 110. The score line 112 delimits an interior part 114 and an exterior part 116 of the sheet of glass.

As illustrated in FIG. 1b, complementary score lines in the form of straight-line segments 118a, 118b, 118c, 118d, also referred to as additional lines, are formed in the exterior part 116, in order to allow correct breaking-out of this part.

This scoring operation (figures a and 1b) is typically performed using a glass-cutting wheel or a laser.

The primitive is then broken out in several steps in order to separate the shape 170 that is to be cut out, from the exterior part 116.

This breaking-out is illustrated in FIGS. 1c, 2a and 2b. It is performed using a technique whereby the exterior part 116 of the sheet of glass 110 is subjected to bending.

As illustrated in FIG. 2a, the sheet of glass 110 is positioned so that it overhangs a breaking-out support 130.

Then a breaking-out tool 140, for example a ball or a wheel, is applied—generally moved—over the exterior part 116 of the sheet of glass, along the score line 112 but offset from this line and with respect to the breaking-out support 130 (emboldened lines in FIG. 1c).

As illustrated in said FIG. 2b, the force applied by the breaking-out tool causes the fissure to spread along the score line through the entire thickness e of the sheet of glass 110.

The exterior part 116, divided into pieces referred to as “offcuts” 171, 172, 173, 174, delimited by the additional lines 118a, 118b, 118c, 118d, is thus detached from the shape 170 that is to be cut out (FIG. 1c).

The quality of the breakout obtained using this technique is not always satisfactory. In some instances, the spreading of the break-out along the contour of the shape that is to be cut out is incomplete or uncontrolled. If it is uncontrolled, the fissure no longer follows the score line, generating scrap. Also, it is possible for the cut edges of the glass to be wavy along the length or to fail to be perpendicular to the two faces of the glass (this is then referred to as non-perpendicular breakout), or defects transverse to the score line and referred to as shells may appear. It has also been found that these problems with quality are more common place when breaking out thin glass, particularly of a thickness less than or equal to 1 mm.

It is an object of the invention therefore to improve the break-out quality of sheets of glass, notably, although nonlimitingly, thin sheets of glass.

To this end, one subject of the invention is a method for breaking out a shape in a sheet of glass, notably a sheet of glass having a thickness less than or equal to 1 mm and more particularly less than or equal to 0.7 mm, said method comprising at least the following steps:

a step of tracing a score line on a first face of the sheet of glass, the score line delimiting an exterior part and an interior part of the sheet of glass,

a step of positioning a support facing said score line on the side of the sheet of glass opposite to said first face, and

a step of breaking out by simultaneous application of at least a first force on the exterior part of the sheet of glass and of at least a second force on the interior part of the sheet of glass.

In the present description, a score line should be understood to mean a fissure intended to allow breaking-out along this line during the breaking-out step. It is therefore a partial cut, which extends over just part of the thickness of the sheet of glass. Note that a score line may define a closed or non-closed contour (for example the score line may pass right across the sheet of glass).

It has been discovered that the application of an additional force to the sheet of glass on the opposite side of the score line to the breaking-out force (first force) allows the quality of the breaking-out to be improved considerably. Thanks to the addition of the second force, the sheet of glass has, near the score line, a behavior that is very close to the way in which it would behave were the interior part of the sheet of glass built in. The second force is chosen to increase the curvature adopted by the surface of the glass at the site of the score line. Thus, the bending moment at this point is increased, causing the glass to break cleanly.

The method according to the present invention is particularly—although nonlimitingly—designed for breaking out glazing of complex shape from a sheet of glass. What is meant here by a complex shape is a line that is curved, or a succession of lines, at least some of which are not rectilinear, or lines which are rectilinear but with changes in direction to form at least one concave part.

A sheet of glass generally has two parallel main faces connected by an edge surface, the dimension of which is very much smaller than those of the main faces. The thickness of the sheet of glass is the distance between the two faces of said sheet.

The first face of the sheet of glass, on which face the score line is traced, is typically the upper face. The second face of the sheet of glass, the opposite face to this first face, is typically the lower face. For the remainder of the present description, two directions are therefore defined, upward and downward, with reference to a direction orthogonal to the upper and lower faces. However, this layout is nonlimiting, and the first face may for example become the lower face and the second face, the upper face, the implementation of the method according to the invention nevertheless remaining the same.

According to one example, the support is designed to allow the exterior part of the sheet of glass to bend under the effect of the first force. With reference to the foregoing, it is noted that the first force is exerted downward and, therefore, the exterior part bends downward.

In general, the support is essentially incompressible. It is made for example from metal or from poly methyl methacrylate (PMMA).

The sheet of glass may be supported directly or indirectly by the support. In other words, the sheet of glass may be in direct contact with the support, or protection means—which are softer—may be interposed between the sheet of glass and the support in order to preserve the sheet of glass at the moment of breakage. The protection means comprise for example a belt, particularly a compressible belt, notably having a shore hardness of between 70 and 90. It may for example be a rubber belt reinforced with polyester fabric.

According to one example, at least a useful portion of the exterior part is situated with an overhang with respect to the support. The first force is exerted on said useful portion.

According to one example, the first force is applied to the exterior part at least at one first point and the second force is simultaneously applied to the interior part at least at one second point, the first and second points being situated facing one another on either side of the score line.

Advantageously, the second force is chosen so that the curvature of the glass is maximized at the score line. In this way, the forces that need to be applied to the glass in order to allow breakout are reduced, accordingly decreasing the risks of spreading of undesired fissures and of scrappage.

In general, the second force is applied to a zone situated near the score line. Advantageously, it is applied to a useful zone situated at a distance away from the score line (measured in a direction orthogonal to said line and parallel to the faces of the sheet of glass) that is comprised between 3 and 30 millimeters, preferably comprised between 5 and 25 millimeters, and more preferably still, between 5 and 15 millimeters.

Advantageously, the second force is applied in a restricted manner (i.e. applied exclusively) to said useful zone.

According to one example, the first and/or the second force is a pressure force applied to the first face of the sheet of glass. This may be a local pressure force. According to one particular arrangement of the invention, the breaking-out step may then be performed by moving, along the score line, a single breaking-out tool equipped with a first local pressure head and with a second local pressure head, these heads being arranged on either side of the score line, the first local pressure head forming a means for applying the first force and the second local pressure head forming a means for applying the second force. Each pressure head comprises for example a ball or a wheel urged elastically toward the first face of the sheet of glass by a pneumatic system that manages the breaking-out pressure or by any other suitable system. According to another example, the first and/or the second force is a planar-pressure force. For example, the second force is applied by means of a plate extending over substantially the entire extent of the interior part of the sheet of glass (i.e. over the entire extent of the interior part or over the entire extent of the interior part except for a peripheral strip running alongside the score line, notably with a width less than 3 mm).

According to yet another example, the first and/or the second force is a suction force. In that case, for example, the support and/or the protection means may be provided with openings for the passage of air.

Note that several types of force may also be combined, if appropriate.

Typically, the first force is moved over the sheet of glass, along the score line. The surface fissure resulting from the scoring step is thus spread along said score line as movement gradually progresses.

The second force may be fixed: it may in particular be applied simultaneously or along the score line. This is the case for example when this second force is applied by means of a plate or sheet creating planar pressure applied to substantially the entire extent of the shape that is to be cut out (substantially all the interior part of the sheet of glass).

It may also be moved over the sheet of glass, along the score line, either continuously or not. In that case, it is generally moved simultaneously with the first force.

By way of an example of discontinuous movement, the first and second force may be applied in succession at various points spaced apart from one another along the score line.

Note, however, that as an alternative, it is the sheet of glass that is moved, or the sheet of glass and the forces. In general, what there is a relative movement of the forces with respect to the sheet of glass.

Advantageously, the support is designed to also allow the interior part of the sheet of glass to bend, under the effect of the second force. Note that the second force is applied downward, and the interior part bends downward. Typically, everything that happens is functionally as if at least one useful portion of the interior part were situated at an overhang with respect to the support. The second force is then applied to said useful portion.

According to one particular arrangement, the support has an internal edge and an external edge which are situated facing the sheet of glass and respectively on either side of the score line. Advantageously, the support has an overall shape corresponding to the trace of the score line: its edges follow the trace of the line. Advantageously, the support extends continuously over the entire length of the score line. Thus, for example, if a sinusoidal line is to be cut, then the support is a strip forming that same sinusoid. If the score line defines a closed contour, then the support advantageously forms a frame defining a closed contour corresponding to the trace of the score line. If the shape to be cut out is square, then the support is a frame of square shape. If the shape is round or oval, then the support is a frame that is round or oval in shape, etc.

By way of alternative, the support may also extend over a restricted portion of the score line. In that case, the support for example takes the form of a block that is fixed or able to move along the score line. In certain embodiments, the support can be moved with respect to the score line, either continuously or not. In particular, the support may be moved together with the first and possibly the second force, in order to cause the fissure to spread along the score line.

Several examples are described in the present description. However, unless specified to the contrary, the features described in connection with one particular example can be applied to another.

The invention will be better understood from reading the following description given solely by way of nonlimiting example and with reference to the attached figures:

FIGS. 1a to 1d schematically illustrate various steps in a method for breaking out a sheet of glass,

FIGS. 2a and 2b are cross-sectional diagrams of the breaking-out of a sheet of glass,

FIG. 3 illustrates the step of breaking out a sheet of glass according to the method of the invention,

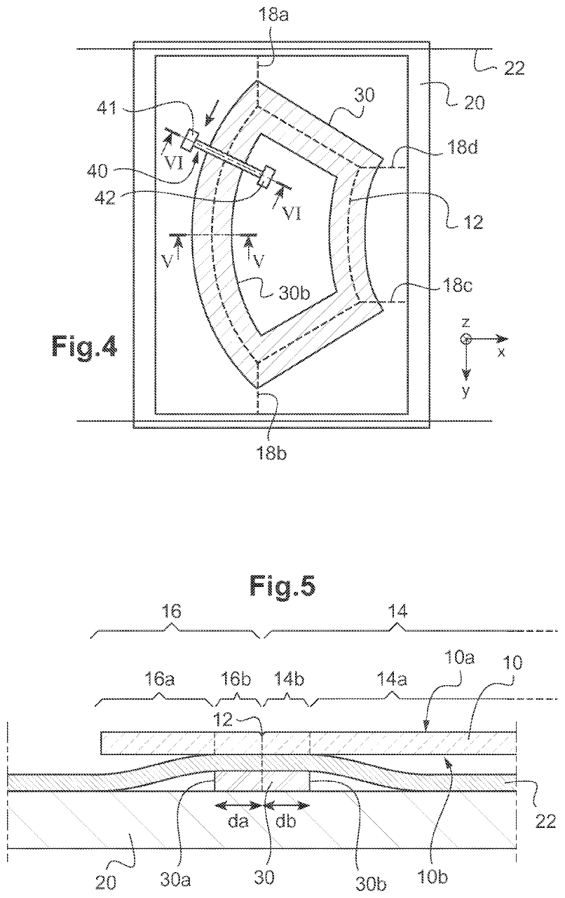

FIG. 4 illustrates a plan view of the sheet of glass placed on a breaking-out support according to a first embodiment of the invention,

FIG. 5 is a schematic view in section on V of FIG. 4, prior to breakout,

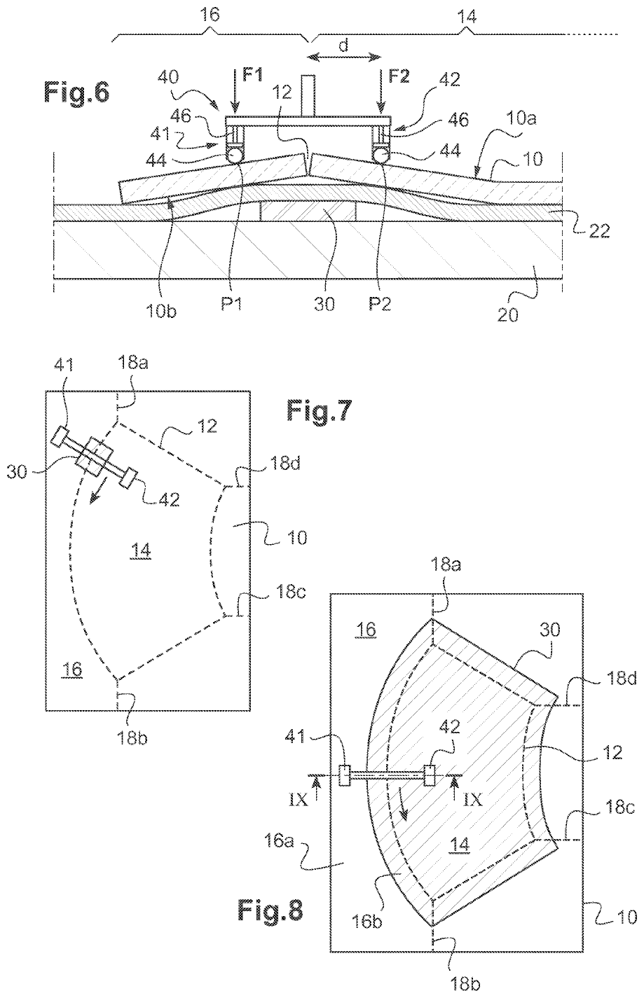

FIG. 6 is a schematic view on section on VI of FIG. 4, illustrating the breaking-out step using a breaking-out tool according to the invention,

FIG. 7 illustrates a plan view of a sheet of glass arranged on a break-out support according to a second embodiment of the invention,

FIG. 8 illustrates a plan view of a sheet of glass arranged on a breaking-out support according to a third embodiment of the invention,

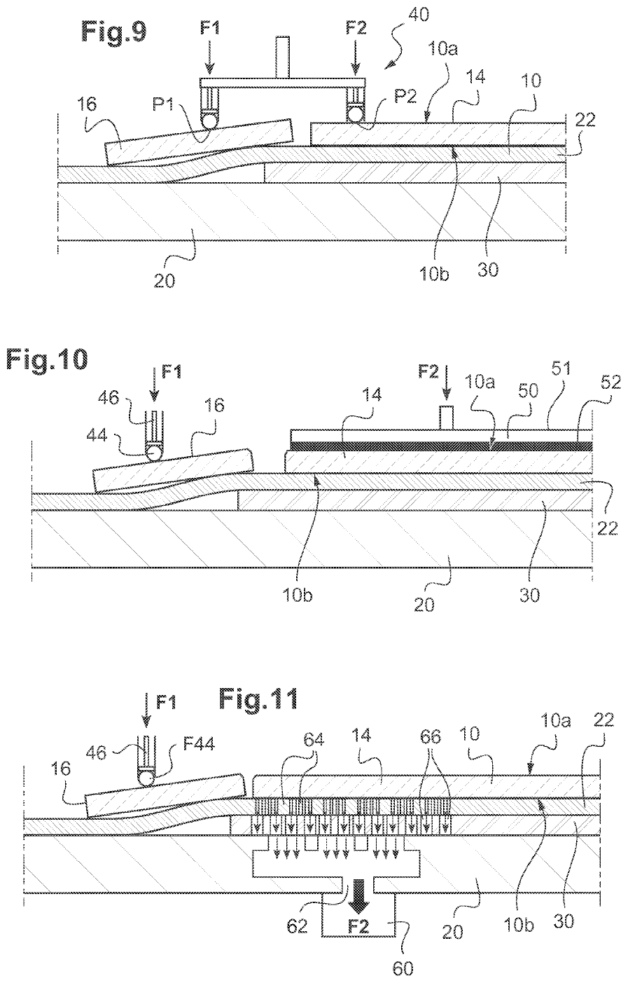

FIG. 9 is a schematic view in cross section on IX of FIG. 8, illustrating the breaking-out step,

FIG. 10 illustrates a fourth embodiment of the invention,

FIG. 11 illustrates a fifth embodiment of the invention.

A first embodiment of the method according to the invention is described hereinbelow in connection with FIGS. 3 to 6, for breaking out glazing of complex shape, particularly automotive glazing such as a windshield.

A first step in the method, which step is illustrated in FIG. 3, is to provide a planar sheet of glass 10, in this instance of rectangular shape, and to trace a score line 12 on a first face 10a of this sheet of glass 10 (see FIG. 5, upper face of the sheet of glass).

The score line 12 delimits, in a direction orthogonal to the score line 12, an exterior part 16 and an interior part 14 of the sheet of glass, the interior part 14 corresponding—in this example—to the contour of the glazing that is to be cut out.

In the known way, additional scores in the form of—generally straight-line —segments 18a, 18b, 18c, 18d are also made in the exterior part 16.

The score line 12 and the additional lines 18a, 18b, 18c, 18d are fissures intended to allow breaking out along this (these) line(s) during the breaking-out step. They are therefore partial cuts, i.e. through only part of the thickness of the sheet of glass.

In the usual way, this step is performed on a scoring table 20 to which the sheet of glass 10 is generally conveyed using a conveyor belt 22.

In the example, the score line 12 and the additional lines 18a, 18b, 18c, 18d are traced by means of a device 24 comprising a glass-cutting wheel, secured to an axle able to be moved translationally in two directions X, Y which are parallel to the sheet of glass, and pivoted about an axis Z perpendicular thereto (FIG. 3).

However, as an alternative, the scoring may be performed using any other suitable scoring instrument, such as, for example, a laser.

For breaking out, the sheet of glass 10 is placed on an essentially incompressible breaking-out support 30 in the form of a sheet or equivalent, for example made of metal, generally supported by a breaking-out table. As illustrated in FIG. 5, the second face 10b of the sheet of glass (the lower face) is then the one facing toward the support 30 and toward the breaking-out table supporting this support.

Advantageously, the sheet of glass 10 is placed on the support 30 via interposed protective means intended to preserve the sheet of glass at the time of breakout.

In the example, the breaking-out table and the scoring table are the one same table 20. The protective means here comprise the conveyor belt 22, for example made of polyester fabric reinforced rubber, which moves the sheet along the production line. The breaking-out support 30 is therefore placed underneath the sheet of glass 10 right from the scoring step. However, in other instances, the scoring and breaking-out steps are performed at different workstations of the production line or the breaking-out support 30 is interposed between the sheet of glass 10 and the table 20 after scoring and before breaking-out.

In the first embodiment illustrated in FIG. 4, the breaking-out support 30 is a fixed support extending over the entire length of the score line 12.

It takes the form of a frame defining a closed contour, the shape of which is corresponds to the contour of the glazing to be cut out. Bounded laterally by an external edge 30a and an internal edge 30b, the support 30 is positioned facing the score line 12 and facing a portion 16b of the exterior part 16 and facing a portion 14b of the interior part 14 of the sheet of glass, which portions are contiguous with the score line 12. It is generally recommended for the support to extent on either side of the score line over a distance da, db respectively, typically equal to at least 3 millimeters.

The support 30 allows the exterior part 16 of the sheet of glass 10 to bend downward (i.e. toward the breaking-out table).

In order to do this, as illustrated in FIG. 5, a useful portion 16a of the exterior part 16 is situated at an overhang with respect to the support. On the other side, a useful portion 14a of the interior part extends beyond the support 30. Functionally, and taking the flexibility of glass into account, everything happens as if the useful portion 14a were at an overhang with respect to the support 30.

The breaking-out, illustrated in FIG. 6, is performed by a technique of subjecting the sheet of glass 10 to bending, inducing tensile load in the glass at the score line 12.

According to the invention, two forces F1 and F2 are applied simultaneously to the sheet of glass 10 in a direction orthogonal to said sheet and downward.

A first force F1 is applied to the useful portion 16a of the exterior part 16.

A second force F2 is applied to the useful portion 14a of the interior part 14, near the score line 12, generally to a zone situated at a distance d from the score line 12 comprised between 3 and 30 millimeters, preferably between 5 and 25 millimeters, more preferably still, between 5 and 15 millimeters, in a direction orthogonal to said line.

In the (nonlimiting) embodiment illustrated, the first and second forces F1 and F2 are applied using a single tool 40 having two pressure heads 41, 42. Each head 41, 42 for example comprises a ball 44 urged elastically toward the first face 10a of the sheet of glass 10 by a pneumatic system 46 that manages the breaking-out pressure ensuring contact between the ball and the glass, or by any other suitable system, possibly a spring. Each ball 44 presses locally at a point P1, P2 of the sheet of glass respectively. Note that, as an alternative, the tool may have wheels in place of the balls 44.

The tool 40 is intended to be moved continuously along the score line 12 so as to cause the fissure in the glass to spread progressively along the entire score line 12. Note that it is generally necessary, for complex shapes, for the tool to be able to be moved in two perpendicular directions X, Y and in rotation about an axis Z orthogonal to X, Y, so that the axis connecting the two heads remains substantially perpendicular to the score line throughout the movement.

As illustrated in FIG. 6, under the effect of the first and second forces F1, F2 respectively, the exterior 16 and interior 14 parts bend downward.

The simultaneous application of the first and second force F2 increases the bending moment applied to the surface of the glass at the score line 12, ensuring a clean break (FIG. 6).

Advantageously, the point P2 of application of the second force F2 and the intensity of this force are chosen so that the curvature of the surface of the glass is highest at the score line.

FIG. 7 illustrates a second embodiment.

Only the form of the break-out support 30 differs from the first embodiment. The other features described hereinabove are therefore not repeated a further time.

According to this second embodiment, the break-out support 30 is a local support of the block type, which extends over only a section of the score line 12, in the longitudinal direction of said line. The dimensions of its surface intended to face the sheet of glass 10 are for example comprised between 5 and 15 cm.

In the example, the local support 30 is mobile: in order to spread the fissure along the score line 12, the support 30 is for example moved opposite the score line 12 at the same time and in the same way as the means for applying the forces F1 and F2, notably so that the points of application of the forces F1 and F2 and the support 30 remain aligned orthogonally to the score line 12.

Note that according to an alternative form, the local support 30 could also be fixed. In that case, it is generally necessary to fit several blocks individually along the score line 12 in order to ensure that the fissure spreads correctly all around the contour of the shape.

FIGS. 8 and 9 illustrate a third embodiment.

As illustrated in FIG. 8, the break-out support 30 here has the form of a solid plate supporting the interior part 14 of the sheet of glass 10 over its entire extent, as well as a portion of the exterior part 16 which is contiguous with the score line, only a peripheral useful portion 16a of the exterior part 16 of the sheet of glass finding itself overhanging relative to the support 30.

According to the invention, a first force F1 is applied to the useful portion 16a of the exterior part 16, and a second force F2 is applied to the interior part 14, near the score line 12.

The deformation of the sheet of glass as a result of the application of F1 and of the flexibility of the glass is prevented in places at which this second force F2 is applied. In these places, the sheet of glass 10 remains substantially parallel to the scoring table 20 and to the support 30. In fact, the bending moment applied to the surface of the glass is increased at the score line 12, allowing a clean break.

FIG. 10 illustrates a fourth embodiment. Here, the means of applying the second force F2 are pressure means in the form of a plate or sheet 50, applied to the first face of the sheet of glass in a linear movement (vertical, see figure) for example by means of a pneumatic system. The plate here comprises an essentially incompressible body 51, for example made of metal or PMMA, and a more flexible covering 52 intended to avoid the creation of surface defects on the glass, on its side designed to come into contact with the sheet of glass 10.

The force F2 applied to the first face 10a of the sheet of glass 10 using the plate 50 is a planar pressure force—directed toward the support—uniformly or near-uniformly applied to practically the entire extent of the interior part of the sheet of glass.

Advantageously, the plate 50 has dimensions slightly smaller than those of the shape to be cut out and extends over all of the interior part of the sheet of glass except for a peripheral strip, notably of width less than 3 mm. It may thus already be in place prior to scoring, in order to hold the sheet of glass 10.

For the remainder, and according to one nonlimiting example, the break-out support 30 is identical to that of the third embodiment and the first force F1 is applied by means of a tool having a single pressure head comprising a ball 44 urged toward the first face of the sheet of glass by means of a system that manages the breaking-out pressure applied pneumatically.

Note that according to an alternative form (not depicted), the plate forming the break-out support 30 may also take the form of a hollow frame defining a closed contour, the shape of which corresponds to the contour of the glazing to be cut out. In that case, the contour of the plate runs alongside the score line, either flush therewith or some distance therefrom (typically less than 3 mm therefrom). In that case, the force F2 is a planar pressure force applied uniformly or near-uniformly to a zone situated near the score line, or along the score line.

FIG. 11 illustrates a fifth embodiment, using a breaking-out support 30 identical to that of the third embodiment. The means of applying the second force F2 here are suction means designed to generate a vacuum on the second face 10b of the sheet of glass 10. Advantageously, the second force F2, chosen according to the invention to increase the bending moment of the glass at the score line, is applied exclusively to a useful zone situated a distance away from the score line comprised between 3 and 30 millimeters, preferably between 5 and 25 millimeters, more preferably still, between 5 and 15 millimeters.

The suction means are advantageously arranged under the support, more particularly under the scoring/breaking-out table, and comprise a pump 60, openings 62 made in the table 20, openings 64 in the material of which the conveyor belt 22 is made and openings 66 in the support 30. The openings may be holes of greater or lesser size made in the material or may be formed as a result of the natural porosity of the material.

1. A method for breaking out a sheet of glass, comprising:
tracing a score line on a first face of the sheet of glass, the score line delimiting an exterior part and an interior part of the sheet of glass,
positioning a support facing said score line on the side of the sheet of glass opposite to said first face, and
breaking out by simultaneous application of at least a first force on the exterior part of the sheet of glass and of at least a second force on the interior part of the sheet of glass.

2. The method as claimed in claim 1, wherein the support is designed to allow the exterior part to bend under the effect of the first force.

3. The method as claimed in claim 1, wherein at least a useful portion of the exterior part is situated with an overhang with respect to the support.

4. The method as claimed in claim 1, wherein the first force is applied to the exterior part at least at one first point and the second force is simultaneously applied to the interior part at least at one second point, the first and second points being situated facing one another on either side of the score line.

5. The method as claimed in claim 1, wherein the second force is chosen so that a curvature of the surface of the glass is highest at the score line.

6. The method as claimed in claim 1, wherein the second force is applied to a zone situated at a distance from the score line comprised between 3 and 30 millimeters.

7. The method as claimed in claim 1, wherein the second force is a local pressure force.

8. The method as claimed in claim 7, wherein the breaking-out is performed by moving, along the score line, a single breaking-out tool equipped with a first local pressure head and with a second local pressure head, the first and second local pressure heads being arranged on either side of the score line, the first local pressure head forming a means for applying the first force and the second local pressure head forming a means for applying the second force.

9. The method as claimed in claim 1, wherein the second force is a planar pressure force.

10. The method as claimed in claim 1, wherein the second force is a suction force.

11. The method as claimed in claim 1, wherein the support is arranged to allow the interior part of the sheet of glass to bend under the effect of the second force.

12. The method as claimed in claim 1, wherein the first force is moved over the sheet of glass, along the score line.

13. The method as claimed in claim 1, wherein the second force is moved over the sheet of glass, along the score line.

14. The method as claimed in claim 1, wherein the second force is fixed.

15. The method as claimed in claim 1, wherein the support has an internal edge and an external edge which are situated facing the sheet of glass and respectively on either side of the score line.

16. The method as claimed in claim 1, wherein the support forms a frame defining a closed contour corresponding to the trace of the score line.

17. The method as claimed in claim 1, wherein the support extends continuously over the entire length of the score line.

18. The method as claimed in claim 1, wherein the support extends over a restricted portion of the score line.

19. The method as claimed in claim 1, wherein protection means are interposed between the sheet of glass and the support.

20. The method as claimed in claim 1, wherein the sheet of glass has a thickness less than or equal to 1 mm.
